(19) United States
(12) Patent Application Publication
(10) Pub. No.: US 2003/0091804 A1
(43) Pub. Date: May 15, 2003

(54) Fiberboard which includes coconut mesocarp and process for making the same

(76) Inventors: Kai Fu Li, Jiangmen (CN); Charles Sing Chuk Chan, Kowloon (HK)

Correspondence Address: BAKER & BOTTS, 30 ROCKEFELLER PLAZA, NEW YORK, NY, 10112

(21) Appl. No.: 10/038,019

(22) Filed: Nov. 9, 2001

(51) Int. Cl. B32B 21/02

(52) U.S. Cl. 428/292.4; 428/297.4; 156/166

(57) ABSTRACT

Article of manufacture, board and process of manufacture of the same are provided. The board preferably includes coconut mesocarp fibers, and can be a medium density fiber board. The board is composed of at least 40-50% of the coconut mesocarp fibers. The board can also include at least one outer portion and at least one inner portion, and the coconut mesocarp fibers of the inner portion can be larger that the coconut mesocarp fibers of the outer portion. The process produces the board preferably includes coconut mesocarp fibers which can composed of at least 40-50% of the coconut mesocarp fibers.

### BACKGROUND OF INVENTION

Fiberboards are conventionally composed of timber products, for which the demand is exceeding the current supply. Coconut mesocarp is a waste product of annual coconut plants, so it is relatively inexpensive, and can be sustained annually.

Cocus nucifera L. is a plant belonging to the Cosos genus of the palmae family. At present the total cultivated area of coconut is 10.583 million hm² worldwide, among which the cultivated area of Indonesia is the largest (accounting for 31.3% of the world's coconut production), and the Philippines second (with 29.4%). India, Sri Lanka, Thailand, Vietnam, Malaysia, New Guinea, and China also account for substantial portions of the world's coconut production annually.

The fruit of the coconut is round, elliptical, or three-edged consisting of the epicarp, mesocarp, endocarp, testa, coconut meat, and coconut water. The epicarp has leather-like texture, and is brown when ripened and smooth on the fruit's surface. The mesocarp is a reddish-brown layer, sometimes called the coconut coir, which is of loose and soft texture consisting of hard fibers and thin wall cells. The thin wall cells became powdery when broken.

A medium density fiber board (“MDF”) was first introduced by Acoustic Elotex Board Company of the United States in 1965. Since then, there have been investment and construction in this field. For example, in 1988, there were 63 factories throughout the world manufacturing MDF, whose total production capacity reached 5.70 million m3. By 1999, the number of such factories reached 255, with a total production capacity of MDF being 25.73 million m3. Thus, the annual growth rate of MDF's production, from 1988 to 1999, has been 31.9%. Because MDF features smooth surface, evenness, uniform quality, fine texture, big ratio of strength to weight, and is easy to sculpt, finish, and saw and cut, etc., it is the ideal raw material for furniture, indoor finishing and chassis. As more users are familiarized with MDF, it continues to undergo a rapid development. It is predicted that the production capacity will likely reach 27 million m³ by 2000, and the output of MDF will count for 10% of total artificial boards in the world. The United States is the biggest producer of MDF, and there were 20 factories in 1999 with a total production capacity of 3.266 million m3, counting for 12.7% of total output of the world.

MDF which utilizes timber naturally requires timber as the raw material, while a coconut MDF (“CMDF”) only requires a “waste” product of the coconut, i.e., the coconut mesocarp. In People's Republic of China, the present costs of manufacturing MDF with logs small in diameter per m³ is 17/15th of the cost for manufacturing CMDF for m³; thus providing saving 2/15 of the cost per m³. What's more, the fire resistance and ability to hold screws and nails of the timber MDF are not as strong as those of CMDF.

Accordingly, it is one of the objects of the present invention to alleviate the supply and demand of timber, and effectively utilize the coconut mesocarp for producing boards such as medium density fiberboards. It is a further object of this invention to produce CMDF of various thickness and breadth by, e.g., adopting the technology of hot grinding to turn the coconut mesocarp into fine fibers which may further undergo the processes of gluing, drying, shaping, pre-pressing, and hot compression.

### SUMMARY OF THE INVENTION

In accordance with the invention, an article of manufacture can be provided which includes a board having coconut mesocarp fibers. The board can be a medium density fiber board, with resin, a waterproofing composition and a firming composition. The content of the resin in the board can be about 15-20%, the content of the waterproofing composition may be about 1%, and the content of the firming composition can be about 1%. It is possible for the board to have a density of about 0.65-0.80 g/cm³.

In another embodiment of the present invention, the board is composed of at least 40-50% of the coconut mesocarp material. In addition, the board can include at least one outer portion and at least one inner portion. The coconut mesocarp fibers of the inner portion may be larger that the coconut mesocarp of the outer portion.

According to yet another embodiment of the present invention, a process for producing a board can be provided. In this exemplary process, the fibers of the coconut mesocarp are received. Then, the received coconut mesocarp fibers are included in the formation of the board. Prior to the receipt of the fibers, the coconut mesocarp can be ground into the fibers, an adhesive composition may be applied to the coconut mesocarp fibers, and prior to the board being formed, the coconut mesocarp fibers with the adhesive composition being thereon is dried.

In another embodiment of the process according to the present invention, the board can be formed by shaping the dried coconut mesocarp fibers into at least one rough slab, pre-pressing the shaped rough slab, and hot-compressing the pre-pressed labs to form the board. Also, the coconut mesocarp can be ground by forwarding strips of the coconut mesocarp to a collector, after the strips are dried, providing the dried strips to the blending machine, and, if the dried strips are acceptable, verifying a moisture content of the dried strips. In addition, before the adhesive composition is applied, the method can produce such composition. For example, the adhesive composition can be produced by mixing an adhesive solution and a firming solution to form a mixed solution, providing the fibers of the coconut mesocarp and the mixed solution to a gluing machine, and combining a predetermined amount of resin with the fibers and the mixed solution to form the adhesive composition.

In accordance with yet another embodiment of the present invention, the adhesive-applied fibers can be dried by providing the adhesive-applied fibers to a drying arrangement, activating the drying arrangement to heat-dry the adhesive-applied fibers, and if a moisture content of the dried fibers is unacceptable, continuing drying the adhesive-applied fibers.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 shows a top-level flow diagram of an exemplary embodiment of a process for producing a fiberboard which includes a coconut mesocarp

FIG. 2 shows an exemplary procedure of the process of FIG. 1 for forwarding the coconut mesocarp to an appropriate machinery.

FIG. 3 shows an exemplary procedure of the process of FIG. 1 for grinding the coconut mesocarp into fibers.

FIG. 4 shows an exemplary procedure of the process of FIG. 1 for preparing an adhesive solution for mixing with the coconut mesocarp coir fibers.

FIG. 5 shows an exemplary procedure of the process of FIG. 1 for drying the glue-sprayed coconut fibers.

FIG. 6 shows an exemplary procedure of the process of FIG. 1 for shaping the dried coconut glue-sprayed fibers into a rough coconut mesocarp fiberboard.

FIG. 7 shows an illustration of an exemplary coconut mesocarp fiberboard according to the present invention which can be produced by the process of FIG. 1.

### DETAILED DESCRIPTION

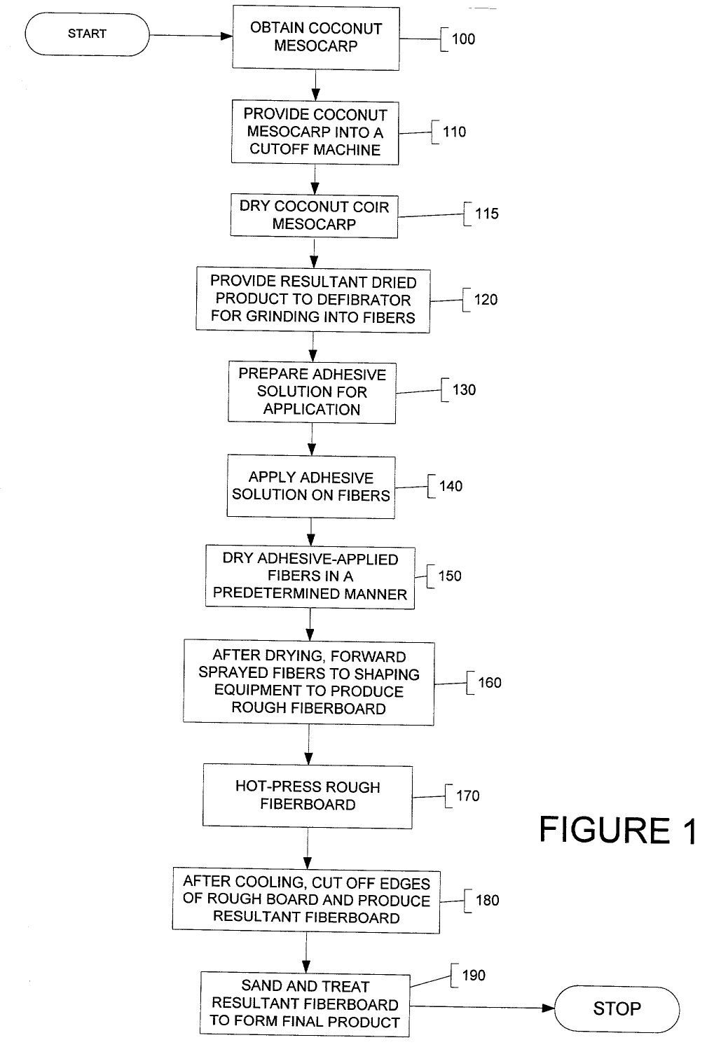

FIG. 1 shows a flow diagram of an exemplary embodiment of a process for producing a fiberboard which includes a coconut mesocarp fibers according to the present invention. In particular, the exemplary process begins by obtaining the coconut mesocarp from internal or external sources (step 100). As indicated above, this coconut mesocarp may be obtained from the already-utilized coconuts, and is preferably extracted from the inner portion of the coconut. Then, in step 110, the coconut mesocarp is provided into a cutting machine via a conveyor to be cut into slices. The sliced coconut mesocarp pieces can then be forwarded to another section of the cutting machine (e.g., to a buffer charging spout of the cutting machine).

According to an exemplary embodiment of the present invention, this section of the cutting machine includes an electromagnetic vibrator and a special unit which forward the coconut mesocarp pieces (that are already in the buffer charging spout) to a heating cylinder in a preferably uniform manner so as to dry the coconut mesocarp pieces. Then, in step 115, these coconut mesocarp pieces are dried.

It should be understood by those having ordinary skill in the art that the electromagnetic vibrator, the special unit and the buffer charging spout can be utilized to detect the presence of metallic substances inside the coconut mesocarp coir pieces, and regulate the flow thereof. As shall be described in further detail below, when these devices detect the metallic substances inside certain coconut mesocarp coir pieces, such coir pieces would be removed from further processing. Then, in step 120, the resultant softened and dried coconut mesocarp slices can be forwarded to a hot grinding area or stage where a defibrator or a millstone device (running at a high speed) can be used to grind these coconut mesocarp slices into coconut coir fibers via friction or pressure.

Thereafter, an adhesive solution can be prepared in step 130. In one exemplary embodiment of the present invention, this preparation can be performed by proportionally pouring a melted paraffin wax into the millstone device during the course of hot grinding, and then provided to a crude lack storage container which holds the gluing solution. A suitable amount of resins and other additives (such as a firming agent, a water-proofing agent, etc.) are directed into this container, e.g., using pumps, to be combined with the dried coconut mesocarp coir fibers. For example, the firming agent (which can be used for accelerating the solidification of the coconut mesocarp) may have a concentration of 20% in the solution at that point of the preparation. According to the present invention, the resin can be urea formaldehyde which is preferably utilized for binding the coconut fiber together. The waterproofing agent can be a wax which is utilized for improving the water-proofing properties of the manufactured coconut fiberboard. Also, the firming agent can be NH₄Cl which is utilized for enhancing and accelerating mat-to-board transformation during pre-pressing pressing stages, the details of which shall be described below. The mixture is thoroughly stirred using a computer-controlled or mechanically controlled mixing arrangement which is known to those having ordinary skill in the art. The mixing process is continued to obtain the desired combination of the resin, waterproof agent, firming agent and coconut mesocarp coir fiber so as to have a particular proportion of the adhesive solution in the final mixture by weight.

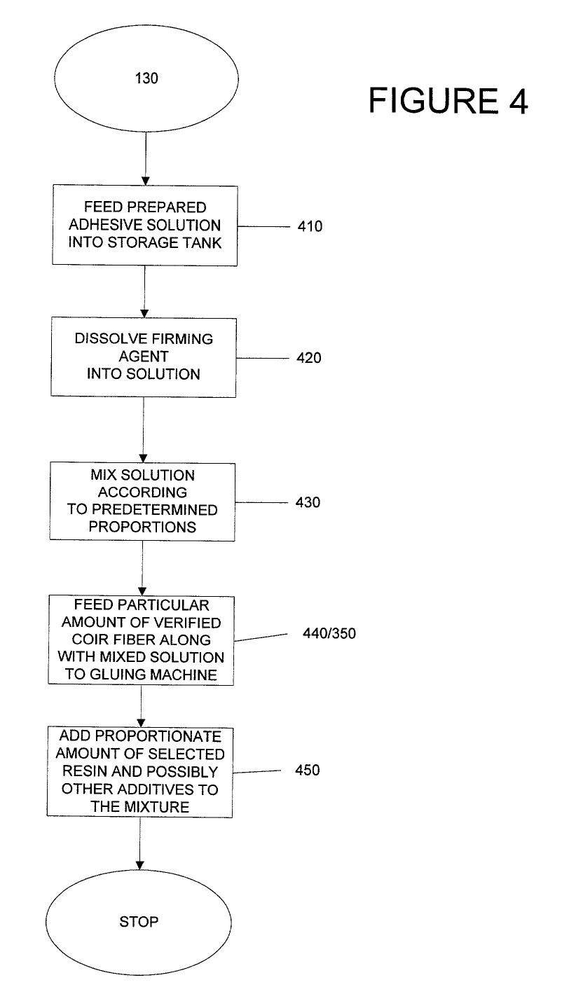

For example, a suitable quantity of the stirred mixture can be directed from the container to the gluing machine via the same or different pumps, which directly spray the mixture into the discharging pipe of the defibrator through a computer-operated or mechanically-operated metrical system (e.g., mechanically-operated pumps), and then the mixture enters the drying pipe. In particular, the mechanically-operated pumps can be used to control the inflow of the adhesive solution from the container to the gluing machine. In addition to the firming agent, the waterproof agent and the adhesive (such as glue) can preferably be applied to the solution. For example, the proportion of the resin in the mixture can be 15-20%, the firming agent as 1.0%, and waterproofing agent also as 1%. After hot grinding of the coconut mesocarp strips, the moisture content of the fibers is about 35-40%, which will likely increase by 6-8% after the application of the above-described materials. Another embodiment for producing an adhesive solution shall be described in further detail below with reference to FIG. 4.

In step 140, the gluing machine preferably evenly and thoroughly sprays or applies the adhesive solution on the coconut mesocarp coir fibers. The input amount of both the coconut coir fibers and the glue mixture are controlled by operator either mechanically or with the use of the computer.

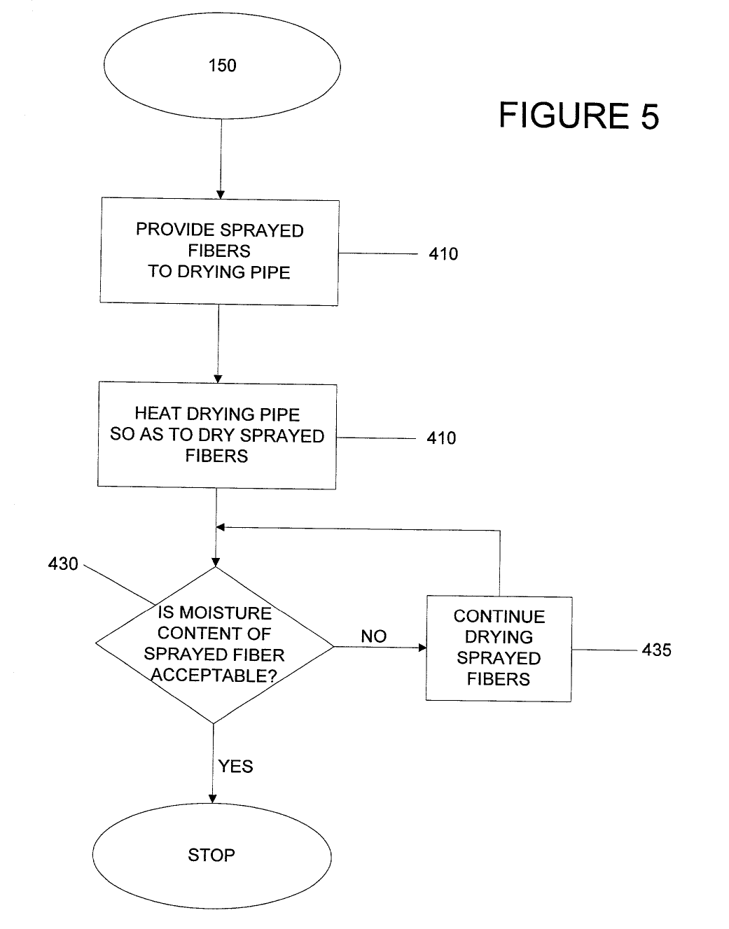

After applying the adhesive solution to the coconut mesocarp coir fibers, these fibers may be dried by, e.g., the single-stage drying system which preferably includes a drying pipe (step 150). For example, before the drying step, the moisture content of the fibers can be approximately 50%, which can be reduced to about 8-12% after such drying step. The drying pipe may have a diameter of 1,250 mm, and a drying capacity of 6,400 kg/h (i.e., to achieve an absolutely dryness). It is preferable to control the relative stability of the moisture content of the coconut mesocarp coir fibers entering the pipe, as well as the stability of the steam quantity provided by the drying pipe. A control system can be established to monitor the moisture content of the coconut mesocarp pieces, the initial moisture content of the coconut mesocarp fibers, the moisture content of the fibers after the drying step, and the appearance of the dried coconut mesocarp fibers. The drying system can also be equipped with an automatic alarm/fire extinguisher system. The heating pipe preferably includes a TCS elliptic pipe steel warping finned-tube radiator so as to improve the heat efficiency. Another embodiment of the drying step according to the present invention shall be described in further detail below with reference to FIG. 5.

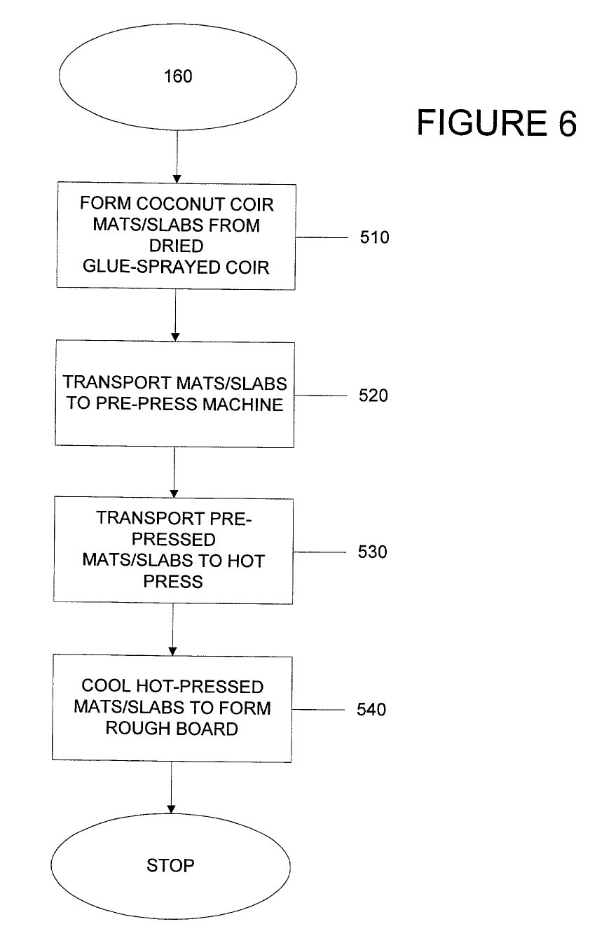

Then, the dried coconut mesocarp fibers can be quantitatively discharged through a metrical charging spout of the drying system, and then forwarded via a conveyor belt, to a feeder which includes a mechanical-spreading machine to be uniformly spread on a net belt using, e.g., the forming head and leveling rollers (step 160). This step can be referred to as a forming/pre-pressing step. For example, the spreading quantity can be controlled by using, for example, a slab metrical scale. The glued coconut mesocarp fibers may have a density of 38 kg/m³, a formation width of 1,460 mm, and a maximum height of 800 mm. It should be understood by those having ordinary skill in the art that the above-described densities, widths and heights are in no way limiting; indeed other densities, widths and/or heights of the glued coconut mesocarp fibers are conceivable, and are clearly within the scope of the present invention. The speed of the conveyer belt at the downstream end of the spreading machine can be 3-15 m/min. Thereafter, the resultant combination can be forwarded to a pre-press machine so as to form, e.g., a rough coconut coir fiberboard. An exemplary detailed embodiment of the forming/pre-pressing step according to the present invention shall also be described below with reference to FIG. 6.

After the pre-pressing step, the thickness of the pre-pressed coconut mesocarp coir fiberboard slabs may be decreased by 50-55%. Also, the rate of resilience of the pre-pressed fiberboard slabs can be 10%, and the pressure may be 0.8-1.0 MPa.

The coconut mesocarp coir fiberboard slabs/mats which are determined to be desirable or acceptable can then be forwarded to a loader device. In particular, a conveyor of the loader device prevents the fiberboard slabs which are already inside the press to be removed from the entry point, and simultaneously push these fiberboard slabs/mats out from the output of the loader device. In this manner, all coconut fiberboard slabs can reach the pressing device to be, e.g., hot-pressed using a hot-pressing apparatus (step 170). For example, the temperature of such heat pressing can be 150-190° C., the production rate of the conveyor belt can be 280 mm/s, the production time of each coconut fiberboard slab may be less than 48 seconds, the time of hot pressing may be 562 seconds (19 mm), the overall cycle would be approximately 610 second, and the pressure may be lower than 3.5 MPa. The press can have a shape of a frame, the diameter of a pommel thereof may be 320 mm, it can include 6 cylinders, and may utilize simultaneous production devices.

After the hot pressing step, the coconut mesocarp coir fiberboard can be forwarded via the conveyor to a cooling panel turnover machine. Such machine can then lower the temperature of the hot-pressed coconut coir mesocarp fiberboard, prevent it from a UF pyrolyzation, reduce the warping transformation of this fiberboard caused by the difference in temperature, and balance the moisture content of the fiberboard. The fiberboard cooled in this manner can be formed into a block which is about 1,220 mm by 2,440 mm using, e.g., a vertical and horizontal edging saw.

Then, following the cooling of the pre-pressed fiberboard slabs, certain portions of the pre-pressed coconut mesocarp coir fiberboard (e.g., its edges) can be cut off so as to produce a standard coconut mesocarp fiberboard or slabs/mats (step 180). Following such cutting procedure, the pre-pressed fiberboard slabs/mats may have the dimensions of, e.g., 1,270 mm×247 mm. Any unqualified or undesirable fiberboard slabs/mats can be discarded into a salvage bin, and then returned to the feed bin of fibers for recycling.

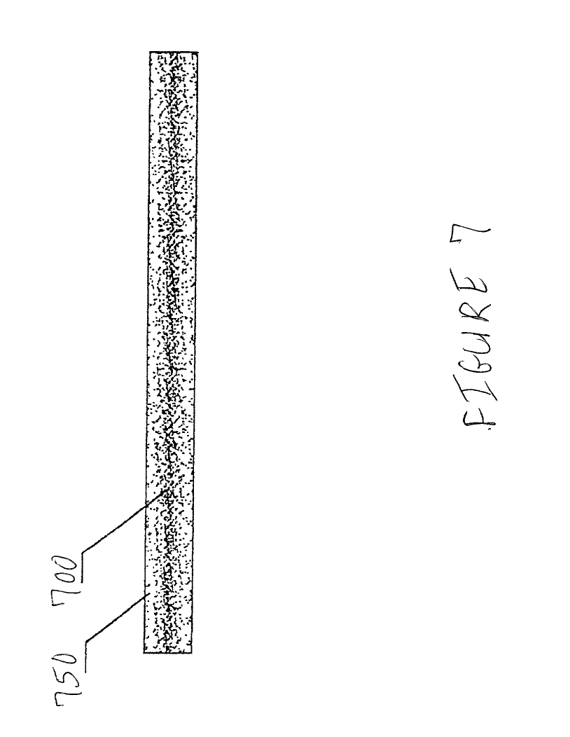

An illustration of an exemplary final coconut mesocarp coir fiberboard is shown in FIG. 7, which includes larger coconut fiber particles 700 positioned closer to the center of the fiberboard, and smaller and finer coconut fiber particles 750 provided closer to the edges of the fiberboard. As shown in this figure, the final coconut mesocarp coir fiberboard may include a significant amount of coconut mesocarp fibers. Indeed, such fiberboards each may include at least 40%, by composition, of the coconut mesocarp coir fibers, and preferably more than 50% thereof by composition. However, it should be understood by those having ordinary skill in the art that there can be different compositions of the coconut mesocarp coir fiber and other materials. One exemplary composition of the final coconut fiberboard can be as follows:

Resin (15%-20%);

Waterproofing agent (about 1%);

Firming agent (about 1%); and

Coconut fiber (the rest).

The resultant coconut mesocarp coir fiberboards can then be stored for 2-5 days at the elevating platform, and then placed in front of a sanding line. For example, the fiberboards may be transmitted through a board pusher and a vertical board introduction roller platform to the wide-band sander with a number (e.g., four) sanding stands so as to initiate sanding of these fiberboards (step 190). Then, the procuring layer can be eliminated, and the fiberboards are made smooth with, possibly, accurate thickness (e.g., the offset of thickness being within±0.30 mm). The sanded fiberboards can be forwarded to the finished-parts warehouse for storage after their inspection and gradation. The leftover pieces and sanding powder, etc. resulting from the above-described processing may be forwarded to the salvage station to be used as, e.g., the fuel of hot-blast stove, thus avoiding a possible secondary pollution.

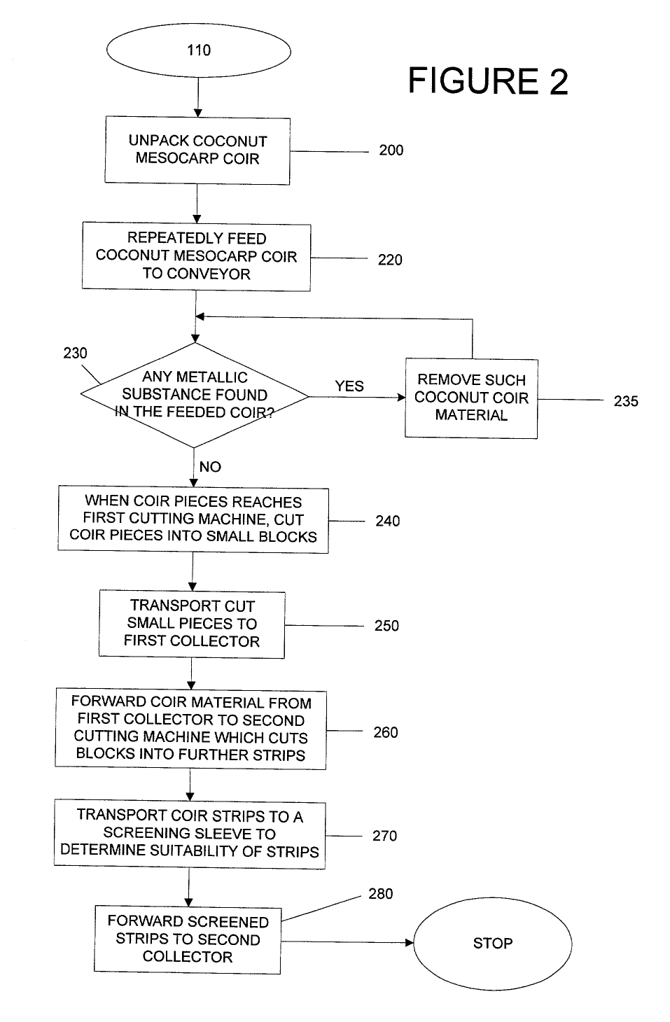

FIG. 2 shows the details of an exemplary embodiment of the procedure of step 110 according to the present invention in which the coconut mesocarp is provided into a cutting machine via the conveyor to be cut into slices. In particular, the coconut mesocarp coir is unpacked (step 210), and repeatedly fed to a conveyor (step 220). Then, in step 230, it is determined whether any metallic substance is found in the feeder coconut mesocarp coir. If so, such contaminated coconut coir material is removed from the conveyor (step 235), and the verifications of step 230 are performed again. Otherwise, when the coconut mesocarp coir pieces reach a first cutting machine, they can be cut into small blocks (step 240), and the small cut-up coir blocks are transported to a first collector (step 250). Then, in step 260, the coir blocks (or materials) are forwarded from the first collector to a second cutting machine which cuts the coir blocks into further strips. Of course, it is conceivable and within the scope of the present invention to use one cutting device (instead of two) to cut the coconut coir materials into blocks first, and then into strips. Then, the resultant coconut mesocarp coir strips are transported to a screening sleeve to determine the suitability of the strips (step 270), and the acceptable/screened strips are forwarded to a second collector for storage (step 280).

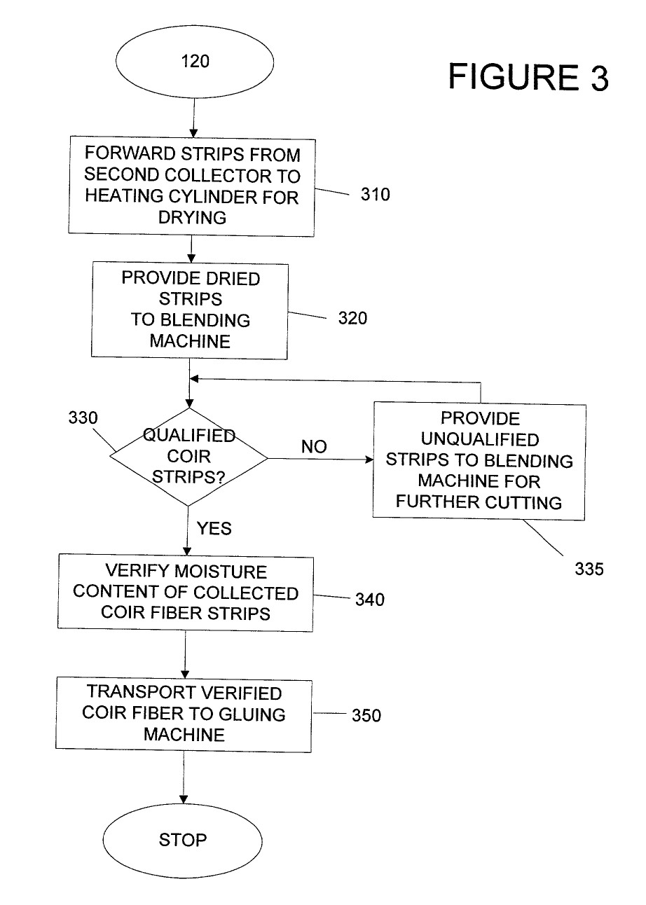

FIG. 3 shows the details of an exemplary embodiment of step 115 according to the present invention in which the screened coconut mesocarp pieces/strips are dried. First, in step 310, the coconut mesocarp coir pieces/strips are forwarded from the second collector to a heating cylinder for drying. Then, the dried pieces/strips are provided to a blending machine (step 320). In step 330, it is determined whether the strips provided to the blending machine are acceptable. If not, the unacceptable (or unqualified) pieces/strips are forwarded to a re-cutting machine to be further cut and then re-circulated again to the blending machine (step 335). Otherwise, in step 340, the moisture content of the qualified (or acceptable) pieces/strips is determined. Thereafter, the qualified pieces/strips are transported to a gluing machine in step 350. It should be apparent that the collected coconut coir pith can be utilized for making a fertilizer as a by-product.

FIG. 4 shows the details of an exemplary embodiment of the adhesive preparation step 130 according to the present invention. In particular, a suitable amount of prepared adhesive solution (e.g., resin) is fed into a storage tank (step 410). Then, in step 420, the firming agent and other additives are dissolved into the adhesive solution in the storage tank. This combination is mixed to predetermined proportions in step 430, and a suitable amount of coconut mesocarp coir fibers and the mixed solution are fed to the gluing machine in step 440. It should be understood that step 440 is either similar to or same as step 350 of FIG. 3. Thereafter, an appropriate amount of selected resin and possibly other additives are added to the mixture in the gluing machine (step 450).

FIG. 5 shows the details of an exemplary procedure of step 150 for drying the coconut glue-sprayed fibers. First, the glue-sprayed coconut mesocarp coir fibers are provided to the drying pipe (step 510), and this drying pipe is heated so as to dry the sprayed coconut coir fibers (step 520). Then, in step 530, it is determined whether the moisture content of the glue-sprayed coconut mesocarp coir fibers is acceptable, i.e., after the glue-sprayed fibers are dried using the drying pipe for a predetermined time. If not, the glue-sprayed coconut mesocarp coir fibers are continued to be dried using the drying pipe until the moisture content of the glue-sprayed fibers becomes acceptable (step 535).

FIG. 6 shows the details of an exemplary procedure of step 160 for shaping the dried glue-sprayed coconut mesocarp coir fibers into the rough coconut mesocarp fiberboard. In particular, the coconut coir mats/slabs are formed from the dried glue-sprayed coconut mesocarp coir fibers (step 610). Then, in step 620, the formed mats/slabs are transported to the pre-pressing machine so that the formed slabs/mats can be pre-pressed. In step 630, the pre-pressed mats/slabs are transported to the hot pressing apparatus. Thereafter, the hot-pressed coconut mesocarp coir mats/slabs are cooled so as to form the rough board (step 640).

It should be appreciated that those skilled in the art will be able to devise numerous embodiments which, although not explicitly shown or described herein, embody the principles of the invention and are thus within the spirit and scope of the present invention.

What is claimed is:

1. An article of manufacture, comprising:
a board which includes coconut mesocarp fibers.

2. The article of manufacture according to claim 1, wherein the board is a medium density fiber board.

3. The article of manufacture according to claim 1, wherein the board further includes a dried adhesive product.

4. The article of manufacture according to claim 3, wherein the dried adhesive product includes resin, a waterproofing composition, and a firming composition.

5. The article of manufacture according to claim 4, wherein a content of the resin in the board is about 15-20%.

6. The article of manufacture according to claim 4, wherein a content of the waterproofing composition in the board is about 1%.

7. The article of manufacture according to claim 4, wherein a content of the firming composition in the board is about 1%.

8. The article of manufacture according to claim 1, wherein the board has a density of about 0.65-0.80 g/cm³.

9. The article of manufacture according to claim 1, wherein the board is composed of at least 40% of the coconut mesocarp fibers.

10. The article of manufacture according to claim 9, wherein the board is composed of at least 50% of the coconut mesocarp fibers.

11. The article of manufacture according to claim 1, wherein the board includes at least one outer portion and at least one inner portion, and wherein the coconut mesocarp fibers of the at least one inner portion are larger that the coconut mesocarp fibers of the at least one outer portion.

12. A medium density board, comprising:
a plurality of coconut mesocarp fibers forming at least part of the board.

13. The medium density board according to claim 12, wherein the coconut mesocarp fibers composed at least 40% of the board.

14. The medium density board according to claim 13, wherein the board is composed of at least 40% of the coconut mesocarp fibers.

15. The medium density board according to claim 12, further comprising a dried adhesive product.

16. The medium density board according to claim 15, wherein the dried adhesive product includes resin, a waterproofing composition, and a firming composition.

17. The medium density board according to claim 15, wherein a content of the resin in the board is about 15-20%.

18. The medium density board according to claim 15, wherein a content of the waterproofing composition in the board is about 1%.

19. The medium density board according to claim 15, wherein a content of the firming composition in the board is about 1%.

20. An article of manufacture, comprising:
a board including a coconut mesocarp material, wherein the board consists of at least 40% of the coconut mesocarp material.

21. The article of manufacture according to claim 20, wherein the coconut mesocarp material includes coconut mesocarp fibers.

22. A medium density board, comprising:
a coconut mesocarp material forming at least a part of the board, wherein the medium density board consists of at least 40% of the coconut mesocarp material.

23. The medium density board according to claim 22, wherein the coconut mesocarp material includes coconut mesocarp fibers.

24. A process for producing a board, comprising the steps of:
receiving fibers of a coconut mesocarp; and
forming the board which includes the coconut mesocarp fibers.

25. The process according to claim 24, further comprising the steps of:
prior to the receiving step, grinding the coconut mesocarp into the fibers;
applying an adhesive composition to the coconut mesocarp fibers; and
prior to the forming step, drying the coconut mesocarp fibers with the adhesive composition being thereon.

26. The process according to claim 25, wherein the forming step includes the substeps of:
shaping the dried coconut mesocarp fibers into at least one rough slab,
pre-pressing the at least one shaped rough slab, and
hot-compressing the at least one pre-pressed labs to form the board.

27. The process according to claim 25, wherein the grinding step includes the substeps of:
forwarding strips of the coconut mesocarp to a collector,
after the strips are dried, providing the dried strips to a blending machine, and
if the dried strips are acceptable, verifying a moisture content of the dried strips.

28. The process according to claim 25, further comprising the step of:
prior to the applying step, producing the adhesive composition.

29. The process according to claim 28, wherein the adhesive composition is produced by:
mixing an adhesive solution, a firming agent and further additives to form a mixed solution,
providing the fibers of the coconut mesocarp and the mixed solution to a gluing machine, and
combining a predetermined amount of resin with the fibers and the mixed solution to form the adhesive composition.

30. The process according to claim 25, wherein the drying step includes the substeps of:
providing the adhesive-applied fibers to a drying arrangement,
activating the drying arrangement to heat-dry the adhesive-applied fibers, and
if a moisture content of the dried fibers is unacceptable, continuing the drying the adhesive-applied fibers.

31. The process according to claim 24, wherein the board is a medium density fiber board.

32. The process according to claim 24, wherein the board further includes a dried adhesive product.

33. The process according to claim 32, wherein the dried adhesive product includes resin, a waterproofing composition, and a firming composition.

34. The process according to claim 33, wherein a content of the resin in the board is about 15-20%.

35. The process according to claim 33, wherein a content of the waterproofing composition in the board is about 1%.

36. The process according to claim 33, wherein a content of the firming composition in the board is about 1%.

37. The process according to claim 24, wherein the board has a density of about 0.65-0.80 g/cm³.

38. The process according to claim 24, wherein the board is composed of at least 40% of the coconut mesocarp fibers.

39. The process according to claim 38, wherein the board is composed of at least 50% of the coconut mesocarp fibers.

40. The process according to claim 24, wherein the board includes at least one outer portion and at least one inner portion, and wherein the coconut mesocarp fibers of the at least one inner portion are larger that the coconut mesocarp fibers of the at least one outer portion.

41. A process for producing a board, comprising the steps of:
receiving a coconut mesocarp material; and
forming the board which includes the coconut mesocarp material, wherein the board consists of at least 40% of the coconut mesocarp material.
